(19) United States
(12) Patent Application Publication
(10) Pub. No.: US 2008/0158903 A1
(43) Pub. Date: Jul. 3, 2008

(54) MOBILE HANDHELD ELECTRONIC APPARATUS WITH LIGHT GUIDE DEVICE

(76) Inventors: Chang-Hong Pan, Taipei County (TW); Chen-Hua Huang, Taipei City (TW); Tzeng-Guang Tsai, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/870,422

(22) Filed: Oct. 11, 2007

(30) Foreign Application Priority Data
Dec. 27, 2006 (TW) 095149274

(51) Int. Cl. F21V 8/00

(52) U.S. Cl. 362/559

(57) ABSTRACT

Disclosed is a mobile handheld electronic apparatus with a light guide device, which includes: at least one user interface; at least one light-emitting device; and a light conducting device, for conducting the light from the light-emitting device to provide desired light to the user interface, wherein the light-emitting device is located between the user interface and the light conducting device, or the light-emitting device is located between the user interface and the light-emitting device. The light conducting device can further comprise: a first light conducting part, for providing desired light for the first user interface; and a second light conducting part, for providing desired light for the second user interface, wherein the first light conducting part and the second light conducting part are integral; and the light-emitting device is located at the border of the first light conducting part and the second light conducting part.

### BACKGROUND OF THE INVENTION

1. Field of the Invention

The present invention relates to a mobile handheld electronic apparatus with a light guide device, and particularly relates to a mobile handheld electronic apparatus with a light guide device having a light-emitting device to provide a desired light source.

2. Description of the Prior Art

The screen of a mobile handheld electronic apparatus requires a light source to provide enough light. Also, for convenience or appearance, other parts of the mobile handheld electronic apparatus need a light source. Normally, a light guide board is utilized to guide the light from a light-emitting device to a specific part of the apparatus.

Such an invention is disclosed in U.S. Pat. No. 6,874,926. FIG. 1 illustrates a prior art mobile handheld electronic apparatus with a light guide device according to U.S. Pat. No. 6,874,926. As shown in FIG. 1, the disclosed invention utilizes special structures (not illustrated in detail) on the light guide board 101 to transmit light from the light source 103 to a desired location, such as in the directions indicated by arrows A, B and C respectively. However, since the light from the light source 103 enters the light guide board 101 from the side, the distances between the light source 103 and all parts of the light guide board 101 are different, and thus the distribution of the light may be non-uniform.

Therefore, a new invention is needed to solve these problems.

### SUMMARY OF THE INVENTION

One objective of the present invention is to provide a mobile handheld electronic apparatus with a luminescent device at a proper location to provide a desired light.

Another objective of the present invention is to provide a mobile handheld electronic apparatus with a luminescent device located in a through hole of the light conducting device, and to fill a medium into the through hole or provide a material layer on the through hole side wall to adjust light density.

One embodiment of the present invention discloses a mobile handheld electronic apparatus with a light guide device, which comprises: at least one user interface; at least one luminescent device; and a light conducting device, for conducting the light from the luminescent device to provide desired light to the user interface, wherein the light-emitting device is located between the user interface and the light conducting device, or the light-emitting device is located between the user interface and the light-emitting device. The light conducting device can further comprise: a first light conducting part, for providing desired light for the first user interface; and a second light conducting part, for providing desired light for the second user interface, wherein the first light conducting part and the second light conducting part are integral; and the light-emitting device is located at the border of the first light conducting part and the second light conducting part.

Another embodiment of the present invention discloses an electronic apparatus with a light guide device, which comprises: at least one user interface; at least one light-emitting device; and a light conducting device, for conducting light from the light-emitting device to provide desired light to the user interface, wherein the light-emitting device has a through hole and the light-emitting device is located in the through hole. The light conducting device can comprise: a first light conducting part, for providing desired light for the first user interface; and a second light conducting part, for providing desired light for the second user interface, wherein the first light conducting part and the second light conducting part are integral; and the through hole is located at the border of the first light conducting part and the second light conducting part.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a prior art mobile handheld electronic apparatus with a light guide device.

FIG. 2 illustrates a mobile handheld electronic apparatus with a light guide device according to an embodiment of the present invention.

FIG. 3-FIG. 8 are sectional diagrams of a mobile handheld electronic apparatus with a light guide device according to an embodiment of the present invention.

FIG. 9 is a vertical diagram of a mobile handheld electronic apparatus with a light guide device according to an embodiment of the present invention.

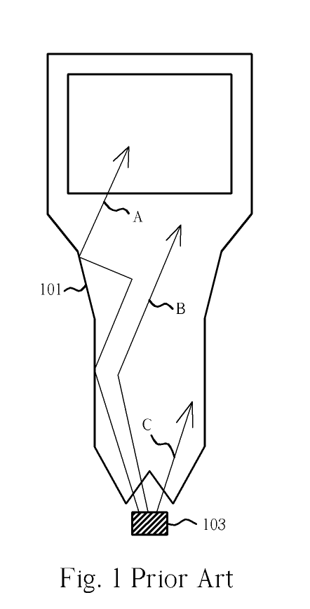

### DETAILED DESCRIPTION

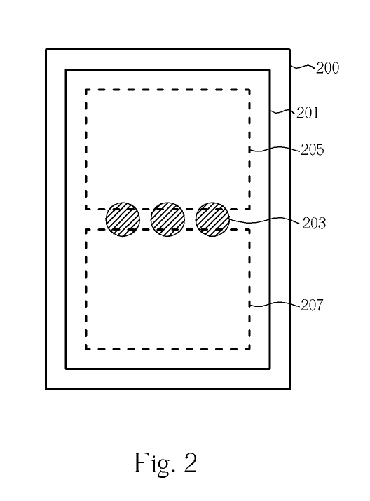

FIG. 2 illustrates a mobile handheld electronic apparatus 200 with a light guide device according to an embodiment of the present invention. As shown in FIG. 2, the mobile handheld electronic apparatus 200 comprises a light guiding device 201, and at least one light-emitting device 203. Since the light-emitting device 203 is located in the range of the light guiding device 201 instead of being located at the side of the light guiding device 201 as in the prior art, the mobile handheld electronic apparatus 200 can have uniform light distribution.

In this embodiment, the mobile handheld electronic apparatus 200 has at least one user interface (not illustrated), and the light guiding device 201 is a light conducting board with a first light conducting part 205 and a second light conducting part 207. The first light conducting part 205 and the second light conducting part 207 respectively provide light to different user interfaces of the mobile handheld electronic apparatus 200. For example, in this embodiment, the first light conducting part 205 provides light to a screen of the mobile handheld electronic apparatus 200, and the second light conducting part 207 provides light to a keyboard of the mobile handheld electronic apparatus 200, but this example is not meant to limit the scope of the present invention. According to the concept disclosed in this embodiment, the light can be provided to other user interfaces of the mobile handheld electronic apparatus 200, and such a modification also falls within the scope of the present invention.

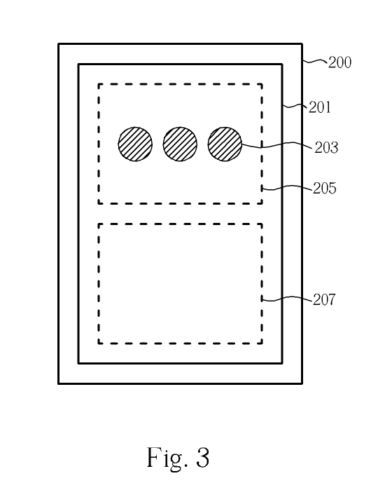

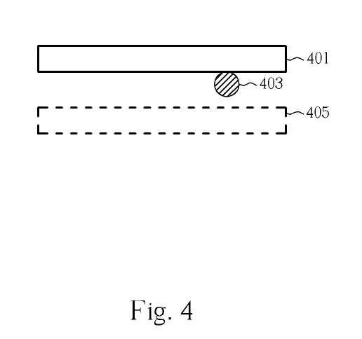

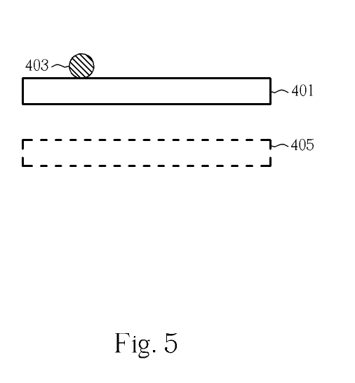

In this embodiment, the first light conducting part 205 and the second light conducting part 207 are integral, and the light-emitting device 203 is located on the border of the first light conducting part 205 and the second light conducting part 207. It should be noted that the light-emitting device 203 can be located on other parts of the light guiding device 201, if necessary. As shown in FIG. 3, the light-emitting device 203 is located on the first light conducting part 205, which also falls within the scope of the present invention. Furthermore, the number of light-emitting devices 203 is not limited to be three as in the embodiments shown in FIG. 2 and FIG. 3, and can be any other number. An example of the light-emitting device utilized in the embodiment of the present invention is an LED (Light Emitting Diode) chip of unlimited types. Alternatively, the light-emitting device 203 can be an object which can luminesce. FIG. 4-FIG. 8 are sectional diagrams of a mobile handheld electronic apparatus with a light guide device according to an embodiment of the present invention, which describes the relation of the light conducting device and the light-emitting device. The light-emitting device 403 can be located between the light conducting device 401 and the user interface 405, as shown in FIG. 4. Alternatively, the light conducting device 401 can be located between the light-emitting device 403 and the user interface 405, as shown in FIG. 5. In the structure shown in FIG. 4 and FIG. 5, the light-emitting device 403 can be directly located on the surface of the light conducting device 401. Alternatively, the light-emitting device 403 can be located on other devices at a distance from the surface of the light conducting device 401, and enough light can also be provided in this situation.

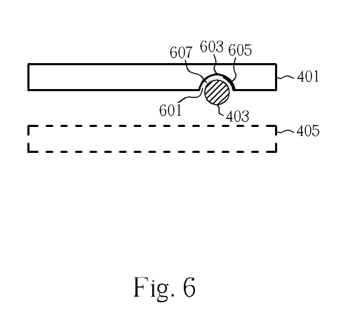

In FIG. 6, the light conducting device 401 has a concave part 601, and the light-emitting device 403 is located in the concave part 601. A material layer 605 is provided on the surface 603 of the concave part 601, such that the light can be refracted or reflected via the material layer 605. Additionally, the concave part 601 can further include a medium 607, of a material different from that of the light conducting device 401, such that the light has different refraction and reflection ratios.

In this embodiment, the medium is air, but this is not meant to limit the scope of the present invention. The light intensity from the light-emitting device 403 can be controlled via the material layer 605 and the medium 607, thus the desired light for the user interface of the mobile handheld electronic apparatus can be obtained. It should be noted that the embodiment shown in FIG. 6 is only given as an example and is not meant to limit the present invention. For example, the concave part 601 is not limited to be situated in the location shown in FIG. 6, and it can be located at any position on the light conducting device 401. Additionally, the material layer 605 and the medium 607 are not limited to be situated in the positions shown in FIG. 6.

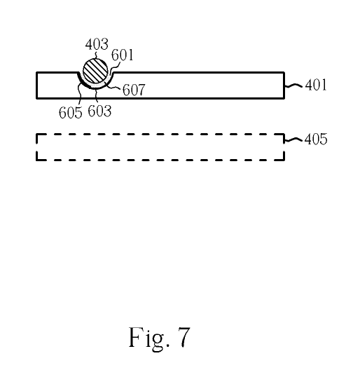

The light-emitting device 403 can be located between the light conducting device 401 and the user interface 405, as shown in FIG. 6. Alternatively, the light conducting device 401 can be located between the light-emitting device 403 and the user interface 405, as shown in FIG. 7

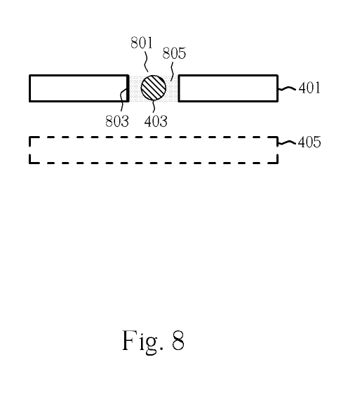

Furthermore, the light conducting device 401 can have a through hole 601, in which the light-emitting device 403 is located, as shown in FIG. 8. Also, as mentioned above, the through hole 801 can have a material layer 803 or a medium 805, to adjust light intensity of the user interface 405.

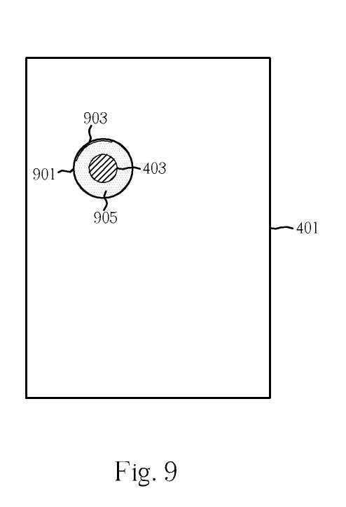

FIG. 9 is a diagram of a mobile handheld electronic apparatus in the vertical plane with a light guide device according to an embodiment of the present invention. As shown in FIG. 9, the light conducting device 401 includes an opening 901, which can be a concave part as shown in FIGS. 6 and 7, or the through hole shown in FIG. 8. Also, the opening 901 can have a material layer 903 or a medium 905, to adjust light intensity of the user interface 405. It should be noted that the above-mentioned embodiment can also be used in other electronic apparatus besides a mobile handheld electronic apparatus.

According to the above-mentioned embodiments, the light intensity of the user interface can be adjusted via the location of the light-emitting device, and the location of the medium or the material layer, such that desired light for a mobile handheld electronic apparatus can be obtained.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mobile handheld electronic apparatus with a light guide device, comprising:
at least one user interface;
at least one light-emitting device; and
a light conducting device, for conducting the light from the light-emitting device to provide desired light to the user interface, wherein the light-emitting device is located between the user interface and the light conducting device, or the light-emitting device is located between the user interface and the light-emitting device.

2. The mobile handheld electronic apparatus of claim 1, comprising a first user interface and a second user interface, wherein the light conducting device comprises:
a first light conducting part, for providing desired light for the first user interface; and
a second light conducting part, for providing desired light for the second user interface, wherein the first light conducting part and the second light conducting part are integral;
wherein the light-emitting device is located at the border of the first light conducting part and the second light conducting part.

3. The mobile handheld electronic apparatus of claim 2, wherein the first user interface is a screen.

4. The mobile handheld electronic apparatus of claim 2, wherein the second user interface is a keyboard.

5. The mobile handheld electronic apparatus of claim 1, wherein the light-emitting device is located on a surface of the light conducting device.

6. The mobile handheld electronic apparatus of claim 5, wherein the surface has a concave part, and the light-emitting device is located on the concave part.

7. The mobile handheld electronic apparatus of claim 5, wherein a medium is located between the light-emitting device and the concave part, and the materials of the medium and the light conducting device are different.

8. The mobile handheld electronic apparatus of claim 7, wherein the medium is air.

9. The mobile handheld electronic apparatus of claim 6, wherein at least part of the inside wall of the concave part is provided with a material layer for controlling the passing or the reflection of light generated from the light-emitting device.

10. The mobile handheld electronic apparatus of claim 1, wherein the light-emitting device is an LED (Light Emitting Diode) chip.

11. The mobile handheld electronic apparatus of claim 1, wherein the light conducting device is a light conducting board.

12. An electronic apparatus with a light guide device, comprising:
at least one user interface;
at least one light-emitting device; and
a light conducting device, for conducting the light from the light-emitting device to provide desired light to the user interface, wherein the light-emitting device has a through hole and the light-emitting device is located in the through hole.

13. The electronic apparatus of claim 1, comprising a first user interface and a second user interface, wherein the light conducting device comprises:
a first light conducting part, for providing desired light for the first user interface; and
a second light conducting part, for providing desired light for the second user interface, wherein the first light conducting part and the second light conducting part are integral;
wherein the through hole is located at the border of the first light conducting part and the second light conducting part.

14. The electronic apparatus of claim 13, wherein the first user interface is a screen.

15. The electronic apparatus of claim 13, wherein the second interface is a keyboard.

16. The electronic apparatus of claim 12, wherein a medium is located between the light-emitting device and the through hole, and the materials of the medium and the light conducting device are different.

17. The electronic apparatus of claim 16, wherein the medium is air.

18. The electronic apparatus of claim 12, wherein at least part of the inside wall of the through hole is provided with a material layer for controlling the passing or the reflection of the light generated from the light-emitting device.

19. The electronic apparatus of claim 12, wherein the light-emitting device is an LED (Light Emitting Diode) chip.

20. The electronic apparatus of claim 12, being a mobile handheld electronic apparatus.

21. The electronic apparatus of claim 12, wherein the light conducting device is a light conducting board.
